(19) United States
(12) Patent Application Publication
(10) Pub. No.: US 2010/0271368 A1
(43) Pub. Date: Oct. 28, 2010

(54) SYSTEMS AND METHODS FOR APPLYING A 3D SCAN OF A PHYSICAL TARGET OBJECT TO A VIRTUAL ENVIRONMENT

(75) Inventors: Brendan McNamara, New South Wales (AU); Oliver Bao, New South Wales (AU); Scott McMillan, New South Wales (AU); Douglas Turk, New South Wales (AU)

Correspondence Address: Muncy, Geissler, Olds & Lowe, PLLC, 4000 Legato Road, Suite 310, FAIRFAX, VA, 22033, US

(73) Assignee: DEPTH ANALYSIS PTY LTD, Ultimo, New South Wales (AU)

(21) Appl. No.: 12/602,303

(22) PCT Filed: May 30, 2008
(86) PCT No.: PCT/AU2008/000781

§ 371 Date: Jun. 16, 2010

(30) Foreign Application Priority Data
May 31, 2007 (AU) 2007902928

(51) Int. Cl. G06T 17/00

(52) U.S. Cl. 345/420

(57) ABSTRACT

Described herein are systems and methods for systems and methods for applying a 3D scan of a physical target object to a virtual environment. Embodiments described herein focus particularly on examples where a 3D scan of a person's head (or part thereof) are to be applied to a virtual body in the virtual environment. In some implementations, this is used to provide realistic faces and facial expressions to virtual characters in a video game environment. In overview, some embodiments make use of a hybrid approach including surface analysis for the generation of a 3D scan, and relatively traditional motion capture (mocap) technology for providing spatial context for association with the 3D scan.

### FIELD OF THE INVENTION

The present invention relates to animation, and more particularly to systems and methods for applying a 3D scan of a physical target object to a virtual environment.

Embodiments of the invention have been developed particularly for allowing a free-viewpoint video based animation derived from video of person's face and/or head to be applied to a virtual character body for use in a video game environment. Although the invention is described hereinafter with particular reference to this application, it will be appreciated that the invention is applicable in broader contexts.

### BACKGROUND

Any discussion of the prior art throughout the specification should in no way be considered as an admission that such prior art is widely known or forms part of common general knowledge in the field.

Various techniques are known for processing video footage to provide 3D scans, and to provide animations based on multiple sequential 3D scans. Typically, a plurality of video capture devices are used to simultaneously capture video of a subject from a variety of angles, and each set of simultaneous frames of the captured video is analyzed and processed to generate a respective 3D scan of the subject or part of the subject. In overview, each video frame is processed in combination with other video frames from the same point in time using techniques applied such as stereo matching, the application of controlled light patterns, and other methods known in the field of 3D photography. A three-dimensional model is created for each set of simultaneous frames, and models corresponding to consecutive frames displayed consecutively to provide a free-viewpoint video-based animation.

It is widely accepted that video-based animation technology has commercial application in fields such as video game development and motion picture special effects. However, applying known processing techniques to commercial situations is not by any means a trivial affair.

It follows that there is a need in the art for systems and methods for applying a 3D scan of a physical target object to a virtual environment.

### SUMMARY

One embodiment provides a method for providing a 3D scan, the method including the steps of
receiving data indicative of video captured at within a capture zone, the capture zone being defined in three dimensional space by the configuration of a set of capture devices;
processing the data based on perceived surface characteristics of the target object, thereby to generate a 3D scan of the target object;
processing the data to identify a reference array, and on the basis of the location of the reference array, processing the captured video to define reference data for association with the 3D scan, the reference data being indicative of one or more characteristics of a scan anchor location for the 3D scan;
outputting a data file including data indicative of the 3D scan and data indicative of the reference data.

One embodiment provides a method for applying a 3D scan of a physical target object to a virtual environment, the method including the steps of:
(a) positioning the target object within a capture zone, the capture zone being defined in three dimensional space by the configuration of a set of capture devices;
(b) defining a reference array within the capture zone on or proximal the target object, the reference array being substantially fixed with respect to a predefined location defined with respect to the target object;
(c) capturing video at the capture devices;
(d) based on perceived surface characteristics of the target object, processing the captured video to generate a 3D scan of the target object;
(e) on the basis of the location of the reference array, processing the captured video to provide reference data for association with the 3D scan, the reference data being indicative of one or more characteristics of a scan anchor location for the 3D scan;
(f) on the basis of the reference data, determining an anchoring transformation for applying the 3D scan to a virtual object in the virtual environment such that the scan anchor location is fixed with respect to a corresponding object anchor location on the virtual object.

One embodiment provides a system for applying a 3D scan of a physical target object to a virtual environment, the system including:
an interface for receiving video data from a set of capture devices, the capture devices defining in three dimensional space a capture zone, the capture zone for containing the target object and a reference array defined on or proximal the target object, the reference array being substantially fixed with respect to a predefined location defined with respect to the target object;
a first processor for, based on perceived surface characteristics of the target object, processing the captured video to generate a 3D scan of the target object;
a second processor for, on the basis of the location of the reference array, processing the captured video to provide reference data for association with the 3D scan, the reference data being indicative of one or more characteristics of a scan anchor location for the 3D scan;
a third processor for, on the basis of the reference data, determining an anchoring transformation for applying the 3D scan to a virtual object in the virtual environment such that the scan anchor location is fixed with respect to a corresponding object anchor location on the virtual object.

One embodiment provides a computer-readable carrier medium carrying a set of instructions that when executed by one or more processors cause the one or more processors to carry out a method for applying a 3D scan of a physical target object to a virtual environment, the method including the steps of:
receiving video data from a set of capture devices, the capture devices defining in three dimensional space a capture zone, the capture zone for containing the target object and a reference array defined on or proximal the target object, the reference array being substantially fixed with respect to a predefined location defined with respect to the target object;
based on perceived surface characteristics of the target object, processing the captured video to generate a 3D scan of the target object;
on the basis of the location of the reference array, processing the captured video to provide reference data for association with the 3D scan, the reference data being indicative of one or more characteristics of a scan anchor location for the 3D scan;
on the basis of the reference data, determining an anchoring transformation for applying the 3D scan to a virtual object in the virtual environment such that the scan anchor location is fixed with respect to a corresponding object anchor location on the virtual object.

One embodiment provides a method of attaching a 3D scan of a face to a virtual body, the method including the steps of:
positioning the face within a capture zone, the capture zone being defined in three dimensional space by the configuration of a set of capture devices;
defining a reference array within the capture zone on or proximal the face, the reference array being substantially fixed with respect to a predefined location defined with respect to the face;
capturing video at the capture devices;
based on perceived surface characteristics of the target object, processing the captured video to generate a 3D scan of the face;
on the basis of the location of the reference array, processing the captured video to provide reference data for association with the 3D scan, the reference data being indicative of one or more characteristics of a scan anchor location for the 3D scan;
on the basis of the reference data, determining an anchoring transformation for applying the 3D scan to a virtual body in the virtual environment such that the scan anchor location is fixed with respect to a corresponding object anchor location on the virtual object.

One embodiment provides a method for applying a 3D scan of a physical target object to a virtual environment, the method including the steps of: receiving data indicative of the 3D scan, the data having associated with it reference data indicative of one or more characteristics of a scan anchor location for the 3D scan;
applying the 3D scan to a virtual space including the target object;
allowing manipulation of the scan in the virtual space to define a relationship between the 3D scan and the virtual object;
on the basis of the manipulation, determining an anchoring transformation for applying the 3D scan to the virtual object in the virtual space such that the scan anchor location is fixed with respect to a corresponding object anchor location on the virtual object.

One embodiment provides a method for providing a 3D scan, the method including the steps of:
receiving video data indicative of video captured at within a capture zone, the capture zone being defined in three dimensional space by the configuration of a set of capture devices;
processing the video data based on perceived surface characteristics of the target object, thereby to generate a 3D scan of the target object;
processing the video data to identify a reference array, and on the basis of the location of the reference array, processing the captured video to define reference data for association with the 3D scan, the reference data being indicative of one or more characteristics of a scan anchor location for the 3D scan.

One embodiment provides a computer-readable carrier medium carrying a set of instructions that when executed by one or more processors cause the one or more processors to carry out a method as discussed above.

One embodiment provides a computer program product for performing a method as discussed above.

### BRIEF DESCRIPTION OF THE DRAWINGS

Embodiments of the invention will now be described, by way of example only, with reference to the accompanying drawings in which:

FIG. 1 schematically illustrates a method for applying a 3D scan of a physical target object to a virtual environment.

FIG. 1A schematically illustrates a further method for applying a 3D scan of a physical target object to a virtual environment.

FIG. 2 schematically illustrates a system for applying a 3D scan of a physical target object to a virtual environment.

FIG. 3 schematically illustrates the transformation of a physical object to a 3D scan in accordance with one embodiment.

FIG. 4 schematically illustrates a method according to one embodiment.

FIG. 5 schematically illustrates normalization of a plurality of sequential 3D scans.

FIG. 6 schematically illustrates a method according to one embodiment.

FIG. 7, FIG. 7A and FIG. 7B provide an example of the method of FIG. 6.

FIG. 8 schematically illustrates a 3D scan anchored to a virtual object.

FIG. 9 schematically illustrates a further embodiment.

### DETAILED DESCRIPTION

Described herein are systems and methods for systems and methods for applying a 3D scan of a physical target object to a virtual environment. Embodiments described herein focus particularly on examples where a 3D scan of a person's head (or part thereof) are to be applied to a virtual body in the virtual environment. In some implementations, this is used to provide realistic faces and facial expressions to virtual characters in a video game environment. In overview, some embodiments make use of a hybrid approach including surface analysis for the generation of a 3D scan, and relatively traditional motion capture (mocap) technology for providing spatial context for association with the 3D scan.

Although the present examples are predominately described by reference to situations where heads and/or faces are applied to virtual characters, it will be appreciated that other embodiments are not limited as such. That is, the physical target object can take substantially any form.

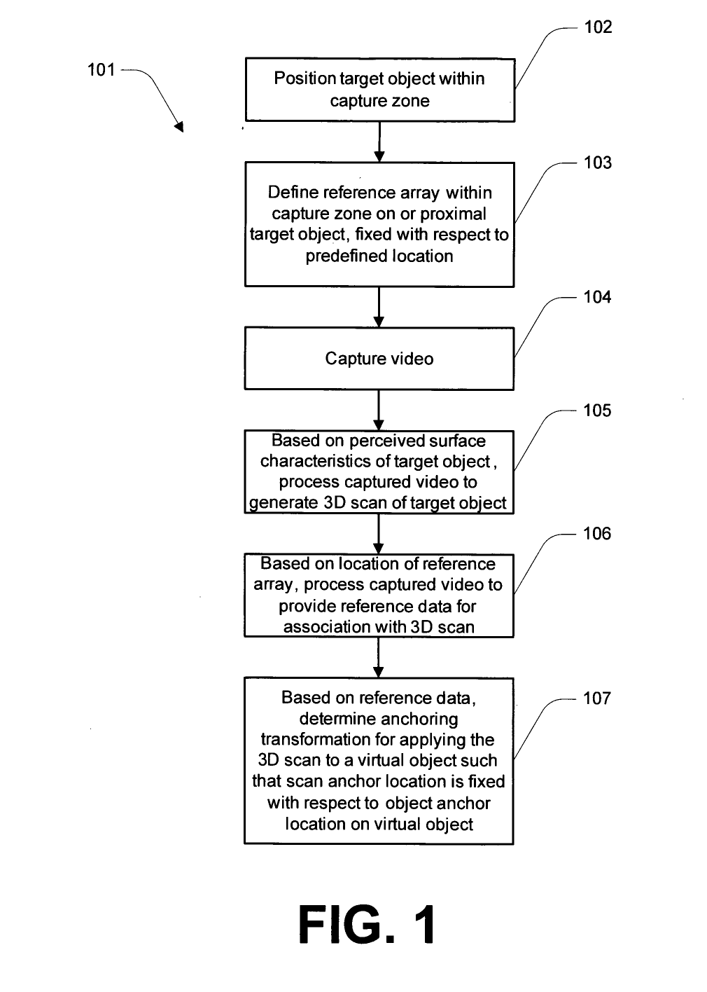

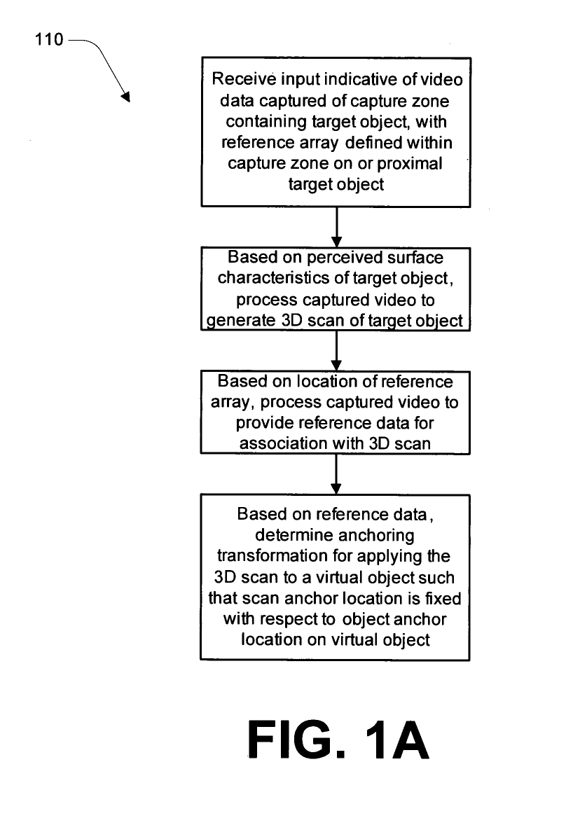

FIG. 1 illustrates a method 101 for applying a 3D scan of a physical target object to a virtual environment. In overview, step 102 includes positioning the target object within a capture zone, the capture zone being defined in three-dimensional space by the spatial configuration of a set of two or more capture devices, such as conventional digital video cameras. Step 103 includes defining a reference array within the capture zone on or proximal the target object. It will be appreciated that this may be performed either prior to or following step 102 (or step 104 below, for that matter). The reference array is substantially fixed with respect to a predefined location defined with respect to the target object. For example, in some embodiments the reference array is provided substantially adjacent the predefined location. By way of example, in a situation where the target object includes a person's head and neck, and the predefined location may be defined at the base of the neck, the reference array may be defined on the person's upper torso. Step 104 includes capturing video at the capture devices. Step 105 includes, based on surface characteristics of the target object, processing the captured video to generate a 3D scan of the target object. Step 106 includes, on the basis of the location of the reference array, processing the captured video to provide reference data for association with the 3D scan. This reference data is indicative of one or more characteristics of a scan anchor location for the 3D scan. In some embodiments the reference data is indicative of one or more characteristics of multiple scan anchor locations for the 3D scan. Step 107 includes, on the basis of the reference data, determining an anchoring transformation for applying the 3D scan to a virtual object in the virtual environment. This anchoring transformation is defined such that the scan anchor location is fixed with respect to a corresponding object anchor location on the virtual object.

The term “physical target object” refers to substantially any physical object, including both animate objects (such a human or animal, or a portion of a human or animal), inanimate objects (such as, tools, clothing, vehicles, models, and the like), and combinations of the two (such as a person wearing a pair of sunglasses). In some embodiments the target object is a portion of a person's head, including a frontal section of the face and neck.

The term “virtual environment” refers to a three dimensional space defined within a processing system. Data indicative of three-dimensional graphical objects (such as a 3D scan or a virtual object) are representable in the virtual environment by way of a screen coupled to the processing system. For example, in one embodiment data indicative of a three-dimensional graphical object is stored in a memory module of a gaming console, and rendered in the context of a virtual environment for output to a screen coupled to the gaming console.

The term “capture zone” should be read broadly to define a zone in three-dimensional space notionally defined by the point-of-view cones of a set of two or more capture devices. Typically a capture zone having a particular location and volume is defined by positioning of a plurality of video cameras, and particular processing algorithms selected based on the type of target object. For example, in one embodiment a capture zone of about 50 cm by 50 cm by 50 cm is used. In some embodiments the capture zone includes a plurality of disjoint subspaces. For example, the cameras are partitioned into groups, and each group covers a disjoint subspace of the overall capture zone.

The terms “capture device” and “camera” as used herein refer to a hardware device having both optical capture components and a processing unit—such as a frame grabber—for processing video signals such that digital video information is able to be obtained by a computing system using a bus interface or the like. In some embodiments the optical capture components include an analogue CCD in combination with an analogue to digital converter for digitizing information provided be the CCD. In some embodiments optical capture components and a frame grabber are combined into a single hardware unit, whilst in other embodiments a discrete frame grabber unit is displaced intermediate an optical capture unit and the computing system. In one embodiment the computing system includes one or more frame grabbers.

The term “transformation” is used to describe a process of converting data between spaces and/or formats. A common example is the conversion from spatial domain to frequency domain by way of Fourier theory. In the present examples, transformations generally allow for the conversion of positions between spaces, such as between an anchoring space and a game space.

Any reference herein to defining a transformation for (or applying a transformation to) a first object should be read to encompass an alternate approach of applying an inverse transformation to a second object. For example, in the context of an anchoring transformation, applying the 3D scan to a virtual object in the virtual environment may include either or both of
A transformation that operates on the 3D scan such that the 3D scan follows the virtual object.
A transformation that operates on the virtual object such that the virtual object follows the 3D scan.

It will be appreciated that these exemplary transformations are in effect inverses of one another.

The spatial configuration of a set of two or more capture devices varies between embodiments. Camera configurations shown in the present figures are provided for the sake of schematic illustration only, and should not be taken to infer any particular physical configuration. For example, the numbers of cameras in various embodiments range from as few as two to as many as one hundred, and perhaps even more in some instances. An appropriate number and configuration of cameras is selected based on available resources and video processing techniques that are to be applied. The general notion is that, by using two spaced apart cameras, it is possible to derive information about depth, and therefore perform analysis of the surface of a target. In some embodiments, the “set” of capture devices includes only a single capture device, for example where surface characteristics are determined based on techniques other than stereo matching.

The term “reference array” is used to describe an array of one or more reference points. That is, in some embodiments a reference array is defined by a single point, whereas in other embodiments there are a multiple points.

The term “reference point” should also be read broadly to include substantially any point in space. In some embodiments reference points are defined or identified using physical objects. For example, colored balls are used in some embodiments, in accordance with a common practice in traditional mocap technology. In some embodiments reference points are defined post-capture. In one embodiment, where the target object includes a face, the tip of the nose of this face is defined as a reference point. In some embodiments markings are used as an alternative of physical object. For example, markings may be defined by paint or ink, or alternately by printed or patterned materials. In some embodiments one or more reference points include transmitters, for example where an electromagnetic-type mocap technique is applied.

The use of three of more reference points is advantageous given that three points in space are capable of defining an infinite plane, and/or a point with a normal. For example, by using three reference points, traditional mocap technology is conveniently used to define a structural template providing specific spatial information. Additionally, three reference points allow for the detection of rotational movements of the infinite plane.

There is discussion herein of the reference array being “on or proximal the target object”. In some embodiments the reference array is on the target object, whilst in other embodiments it is not. In some embodiments the target object is part of a larger object, and the reference array is defined elsewhere on the larger object. For example, in some embodiments the target object includes regions above the base of a person's neck, and one or more reference points are provided below the persons neck—for example on the person's chest and/or back.

In the context of step 105, processing the captured video to generate a 3D scan of the target object is in some embodiments carried out by techniques such as stereo matching and/or the application of controlled light patterns. Such techniques are well understood in the art, and generally make use of multiple camera angles to derive information about the surface of an object, and from this information generate a 3D scan of the object. In some embodiments, the step of processing the captured video based on surface characteristics includes active captured methods, such as methods using structured lights for applying a pattern to the surface.

As used herein, the term “3D scan” refers to a set of data that defines a three-dimensional object in three-dimensional space, in some embodiments by way of data including vertex data. In the present context, the 3D scan is of the target object, meaning that when rendered on-screen the 3D scan provides a free-viewpoint three-dimensional object resembling the target object. The degree of resemblance is dependent on processing techniques applied, and on the basis of techniques presently known it is possible to achieve a high degree of photo-realism. However, the present disclosure is concerned with the application of results generated by such processing techniques, and the processing techniques themselves are generally regarded as being beyond the scope of the present disclosure.

The term “reference data” should also be read broadly by reference to its general purpose: to be indicative of one or more characteristics of a predefined location defined in relation to the target object, which corresponds to a scan anchor location in the context of the 3D scan. In present embodiments these characteristics include spatial characteristics relative to an origin (including 3D offset and rotation), and/or scale characteristics.

Fixing the scan anchor location with respect to a corresponding object anchor location on the virtual object in some embodiments means that as object anchor location moves in the virtual environment, the scan anchor location correspondingly moves. The virtual object is in some cases capable of some movement independent of the object anchor location, and such movement does not affect the object anchor location. Similarly, movement of a 3D scan moves over the course of a 3D scan animation relative to the scan anchor location is possible independent of movement of the object anchor location. For example, in an embodiment considered below, a 3D scan includes a head and neck, and is anchored to a modeled torso. The scanned head is able to rotate about the neck whilst remaining anchored to the torso, and yet without necessitating movement of the torso.

The term “video” should be read broadly to define data indicative of a two-dimensional image. In some instances video includes multiple sequential frames, and therefore is indicative of multiple sequential two-dimensional images. Capturing or processing of video may be carried out in respect of a single frame or multiple frames.

In some embodiments, multiple sequential video frames are captured and processed to generate respective 3D scans. These scans, when displayed sequentially, provide what is referred to herein as a “3D scan animation”.

The term “scan anchor location” should be read broadly to mean a location defined in three-dimensional space relative to the 3D scan. As discussed above, the reference array allows identification of a predefined location in the real world. The scan anchor location generally describes that predefined location in a virtual environment. In some embodiments a predefined location is arbitrarily defined. In some embodiments the target object is capable of movement, and the predetermined location is defined at a portion of the target object about which remains stationary throughout the movement. For example in some embodiments the target object includes a person's neck and head, and the predefined location is defined at the base of the neck. In this manner, the scanned head is still able to move freely over the course of a 3D scan animation without the scan anchor location moving. An scan anchor location is, at least in some embodiments, capable of movement.

In embodiments where step 105 includes generating a plurality of 3D scans as sequential frames defining a 3D scan animation, step 106 includes providing reference data for each one of these sequential frames. That is, each of the 3D scans has associated with it respective reference data, this reference data being defined on the basis of the location of the reference array at the time the relevant video frame was captured. Each reference point must be concurrently viewable by at least two or more cameras to allow 3D position verification, at least where visual mocap techniques are used. It will be appreciated that such a limitation does not apply in the context of electromagnetic-type mocap techniques.

FIG. 1A illustrates a method 110, which is similar to method 100. It will be appreciated that method 110 is a corresponding method to method 100 that is performable in the context of a computing system. For example, in some embodiments method 110 is performable on the basis of software instructions maintained in or across one or memory modules coupled to one or more respective processors in a computing system.

Embodiments described below are particularly focused on a situation where a 3D scan of at least part of an actor's head is applied to a virtual body for use in a video game environment. It will be appreciated that this is for the sake of explanation only, and should not be regarded as limiting in any way. In other such embodiments, other similar techniques for applying an actor's head or face are used. For example, different portions of the actor's body define the target zone in other embodiments. In some embodiments the target zone is defined by the front regions of the face only, in some embodiments the target zone is defined by a full 360 region of the head and neck, in some embodiments the target zone is defined by a full 360 degrees view of the head below the hairline, and so on. Applying these and other variations to the presently described techniques should not be regarded as going beyond the scope of the present invention. Furthermore, other embodiments are implemented in respect of other body parts, objects and so on.

The phrase “for applying a 3D scan to a virtual environment” should not be read to imply a requirement that the 3D scan be actually applied to the virtual environment. Rather, in some embodiments, the 3D scan is simply associated with data that allows it to be later applied to a virtual environment.

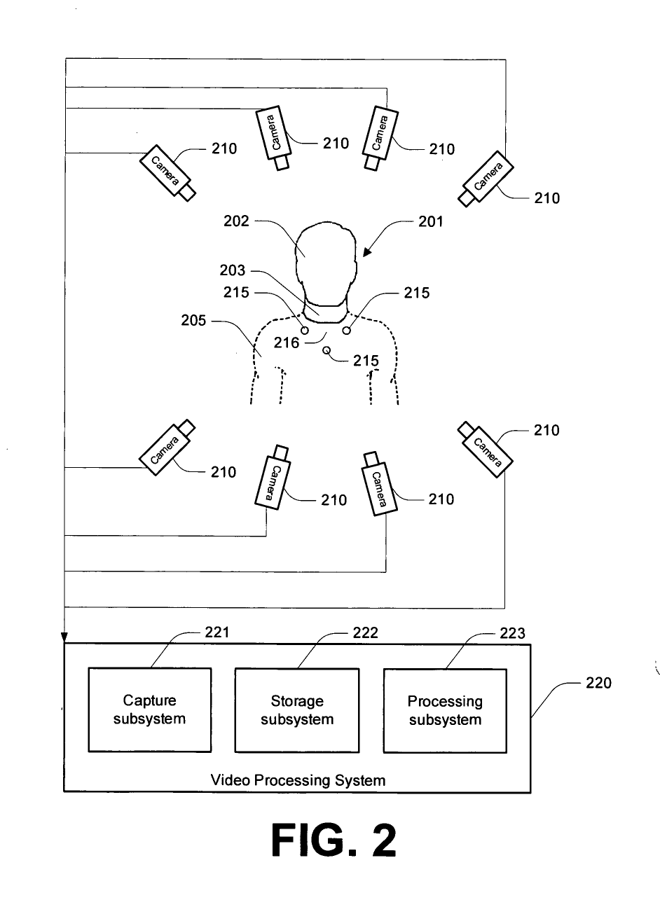

FIG. 2 schematically shows a capture situation. In this embodiment, the target object is in the form of a head portion, referred to herein as head 201. In the present embodiment head 201 is not, in a strict anatomical sense, a “head”. Rather, head 201 includes at least a frontal portion of the head 202 and neck 203 of an actor 204. The precise definition of head 201 relies on camera coverage (for example whether the cameras provide a full 360 degree view of the capture zone) and technical preference (for example how the head is to be applied to a body, and whether hair is to be processed during the 3D scanning procedures). The body 205 of actor 204 is not part of the target object, and the region identified by the “body” is shown in dashed lines to illustrate this point. Capture devices, in the form of cameras 210, define a capture zone 211 that contains head portion 201.

To facilitate the definition of a reference array in the capture zone, three reference points, in the form of three mocap markers 215 (such as colored balls) are affixed to body 205 to define a triangle. The positioning of mocap markers in FIG. 2 is exemplary only, however the illustrated positioning is applied in some embodiments. There are practical advantages in positioning the mocap markers at locations that are unlikely to move as the actor moves his head or neck. For this reason, it is practically advantageous to place first and second mocap markers substantially adjacent the actor's collarbone on the actor's front side, substantially symmetrically with respect to the actor's sternum. The third mocap marker is optionally positioned adjacent the actor's sternum at a lower height than the first and second reference points. In some embodiments where the cameras provide full 360-degree coverage, the third marker is placed adjacent the actor's spine at a cervical or upper thoracic vertebrae. Other positioning techniques are used in further embodiments. Of course, in some embodiments alternate approaches to the positioning of mocap markers are implemented to facilitate definition of reference points.

Generally speaking, reference points are selected based on the virtual object to which a 3D scan is to be anchored. In the present case, a 3D scan of a head and neck is to be anchored to a torso, therefore reference points are defined on a torso so as to define a relationship between 3D scan and virtual object.

In other alternate examples, a single mocap marker defines the reference array. In some such examples, the actor is optionally restrained (for example being strapped to a chair) such that the predefined location on the target object remains substantially still over time, although this is by no means strictly necessary. It will be appreciated that such an approach reduces disadvantages associated with a single-point reference array, as opposed to a three-point array.

In the present example, the predefined location 216 is defined as the center of markers 215, and has orientation with respect to a known infinite plane. However, it will be appreciated that substantially any arbitrary point can be selected, provided that point is fixed with respect to markers 215.

Cameras 210 are coupled to a video processing system 220. As illustrated, this system includes a capture subsystem 221, storage subsystem 222, and processing subsystem 223. In a generic sense, a capture subsystem 221 is responsible for controlling cameras 210, and managing video capture. In some embodiments this includes monitoring captured footage for quality control purposes. Storage subsystem 222 is responsible for storing captured video data, and in some embodiments aspects of this storage subsystem are split across the capture and processing subsystems. Processing subsystem 223 is primarily responsible for generating 3D scans, and performing associated actions. In some embodiments subsystem 223 is coupled to a other information sources for receiving input from game developers and the like. Again, at a generic level, system 220 includes or is coupled to one or more memory modules for carrying software instructions, and one or more processors for executing those software instructions. Execution of such software instructions allows the performance of various methods described herein.

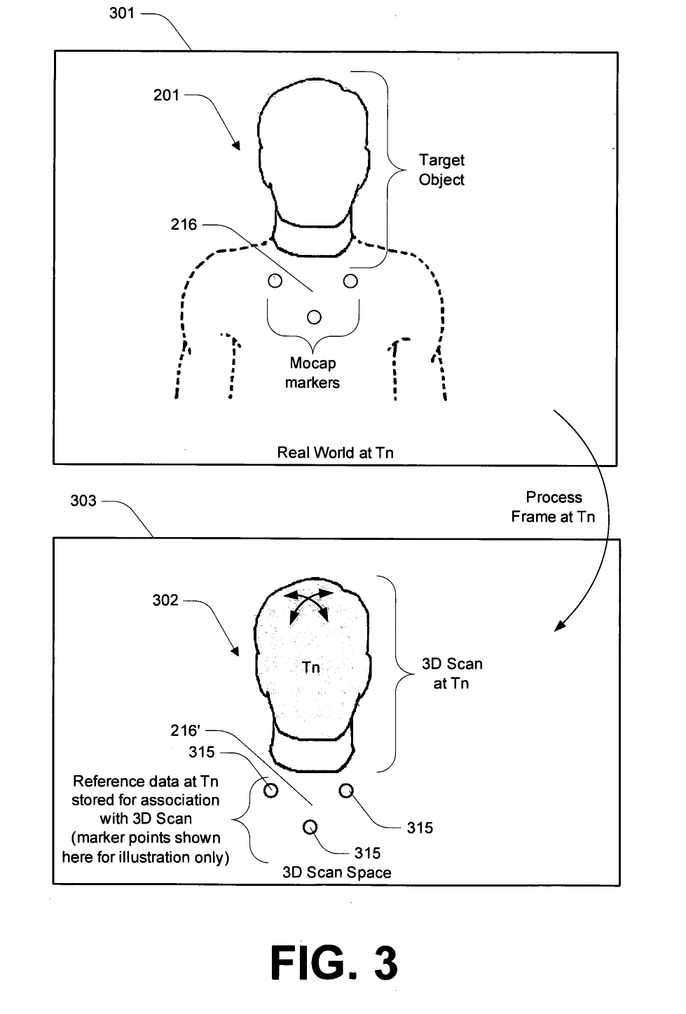

In other embodiments alternate hardware arrangements are used within or in place of system 220. There is detailed discussion of hardware arrangements for managing the processing of 3D scans in Australian Patent Application No. 2006906365 and PCT Patent Application No. PCT/AU2007/001755. FIG. 3 schematically illustrates a process whereby a physical target object, specifically head 201, in the real world 301 is used as the subject of a 3D scan 302 viewable in a 3D scan space 303, also referred to as a capture space. Space 303 is conveniently conceptualized as a construct in a computing system capable of displaying graphically rendered 3D scan data. It will be appreciated that, in practice, a 3D scan is embodied in digital code, for example as a set of vertex data from which the scan is renderable for on-screen display. FIG. 3 is shown in the context of an arbitrary point in time “Tₙ”. A set of simultaneous video frames captured at Tₙ is processed to provide a 3D scan at Tₙ. In some embodiments, processing in the temporal domain is used to improve the quality of a scan at Tₙ.

FIG. 3 shows points 315 in space 303 representative of the locations of mocap markers 215 in the real world. These allowing recognition of scan anchor location 216′ in the context of space 303. Points 315 are shown for the sake of illustration only, and are in the present embodiments not actually displayed in conjunction with an on-screen 3D scan. Rather, these points are maintained as back end data as part of the reference data associated with the 3D scan. That is, in a conceptual sense the reference data is indicative of the spatial location and configuration of these points. The reference data provides information regarding the position and configuration of scan 302 (specifically of scan anchor location 216′), including 3D offset and rotation with respect to a predefined origin in space 303. In the some embodiments the reference data also includes a scaling factor, which is essentially determined by the relative spacing of points 315.

The approach implemented to define extremities of scan 302 varies between embodiments. In the present embodiment the reference data associated with the scan can be used to define a clipping plane through the neck, thereby to define a clean lower extremity. In some embodiments the actor wears clothing of a specified color to assist in background removal. In some embodiments the clipping plane is defined by the union of a plurality of clipping sub-planes. In this manner, the clipping plane may be defined by a complex relatively shape. In further embodiments, clipping surfaces are defined having other shapes, for example using a 3D Gaussian function.

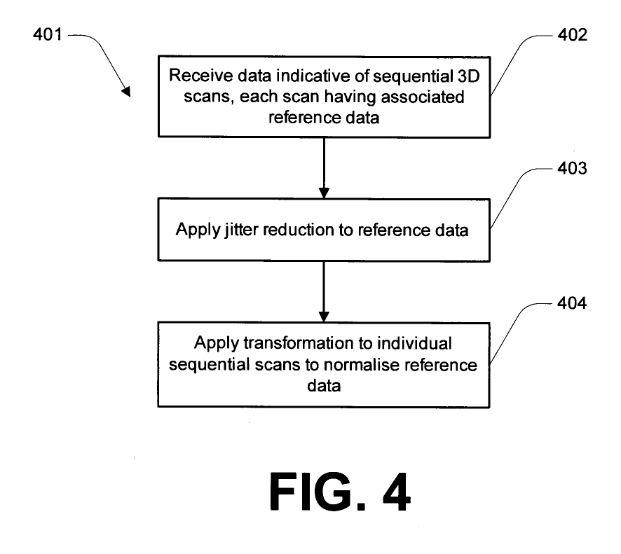

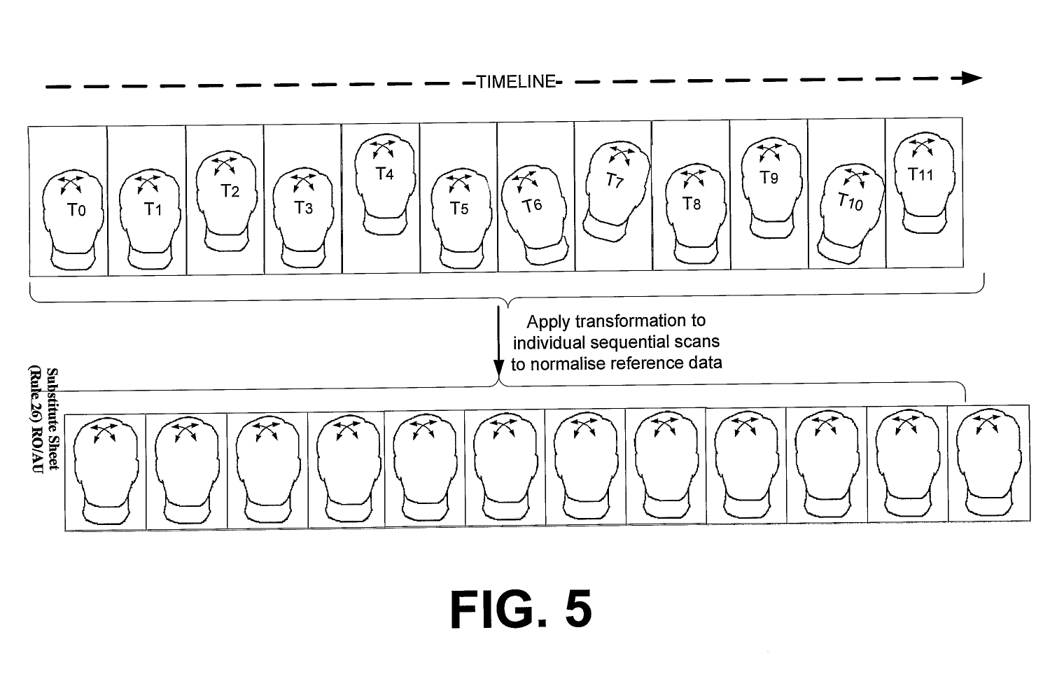

As foreshadowed, in some cases there is a desire not only to apply a stationary 3D scan to a body, but to apply a dynamic 3D scan. One approach for achieving this is to generate multiple sequential 3D scans on the basis of corresponding sequential video frames, thereby defining a 3D scan animation. Methods described herein allow a 3D scan animation (or indeed multiple 3D scan animations) to be anchored to a virtual object without a need to individually anchor each scan in the animation. An exemplary method for allowing this is described by reference to FIG. 4 and FIG. 5.

FIG. 4 illustrates a method 401 for normalizing a plurality of scans, which in this case are sequential 3D scans defining a 3D scan animation. It will be appreciated that the method is equally applicable to non-sequential scans. Data indicative of the scans is received at 402. At 403 a jitter reduction technique is applied such that the relative spacing of points 315 is averaged and normalized across the frames. As a result of this process, the structural template defined by points 315 has a constant scale among the scans (and their associated reference data). In some embodiments the absolute position of each point 315 is also filtered across the frames.

Following the jitter reduction process, the structural templates defined by points 315 typically have different orientations across the scans. For example, during video capture, an actor might move such that the predefined location moves, affecting the reference data and, more particularly, the location of the scan anchor location. In the present context, this might include swaying from side-to-side, turning at the waist, bending at the lower back, and so on. This is schematically illustrated in the upper frames of FIG. 5. Transformations are applied at step 404 to normalize the scans and their associated reference data. Specifically, a normalizing transformation is applied to each of the individual scans to normalize the reference data such that, for each scan, points 315 have the same 3D spatial configuration relative to a predefined origin for space 303. That is, the scan anchor location is in the same configuration for each scan. This is schematically shown in the lower set of frames in FIG. 5. This defines a neutral configuration for the 3D scan, and in the present example this neutral configuration is based on the configuration at T₀. In other examples, rather than using T₀, another frame is used, provided it is in a neutral configuration.

In some embodiments, the normalization of scans at step 404 allows for clipping to be performed across a plurality of frames. For example, normalization is performed based on the configuration at T₀. A clipping plane (optionally defined by the union of a plurality of clipping sub-planes) is graphically manipulated to an appropriate position by reference to the 3D scan at T₀. The clipping-plane is then anchored to that position (for example by reference to the scan anchor position at T₀) across the plurality of frames. A clipping procedure is then performed so as to modify the plurality of 3D scans by way of clipping along the clipping plane. This defines a common extremity for the plurality of scans. Of course, some fine-tuning may be required for optimal results.

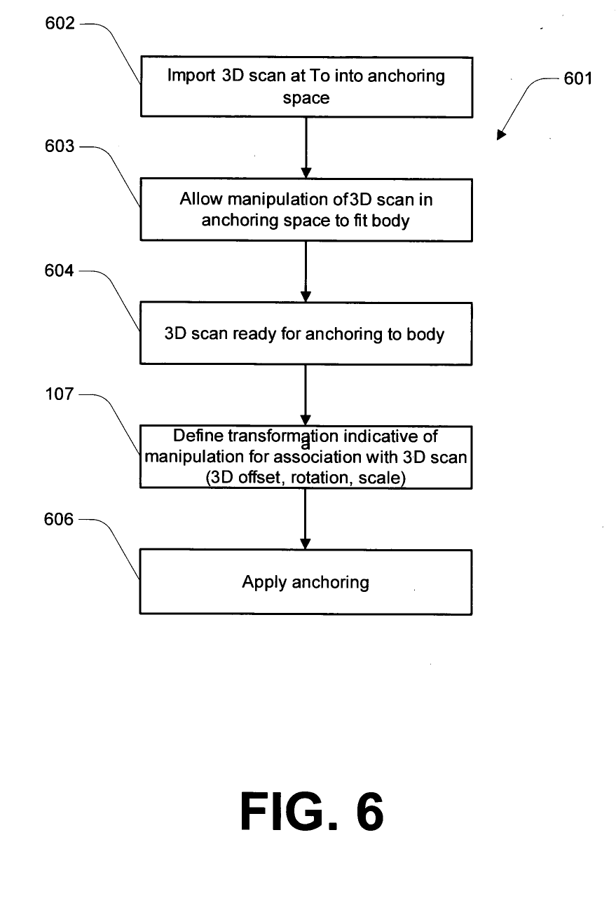

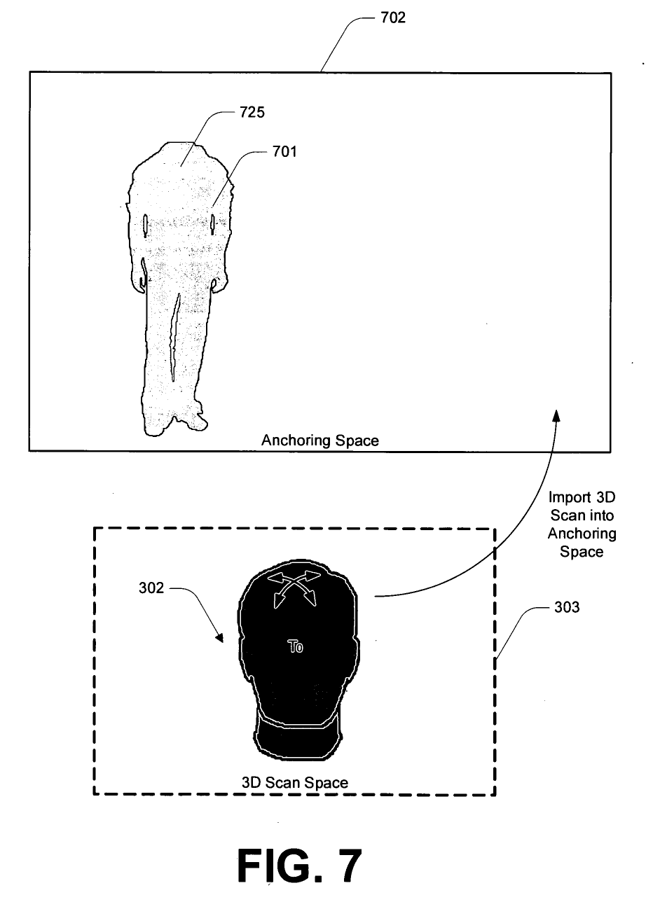

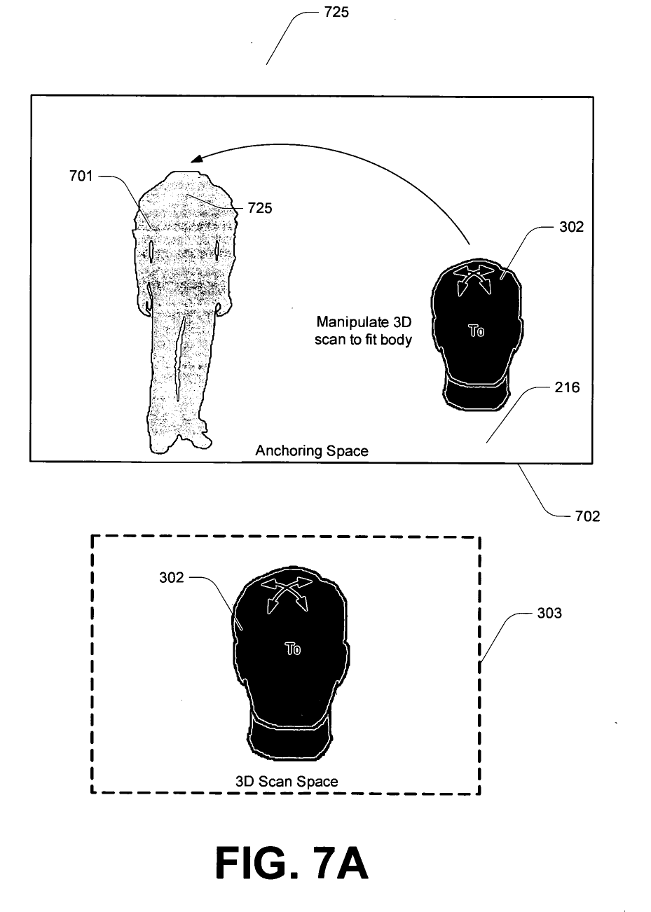

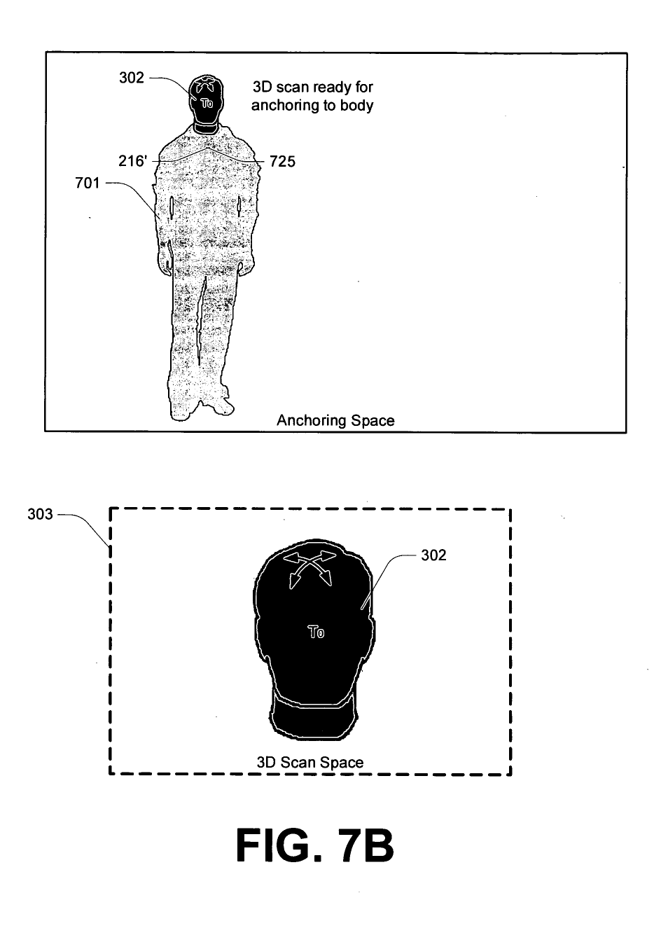

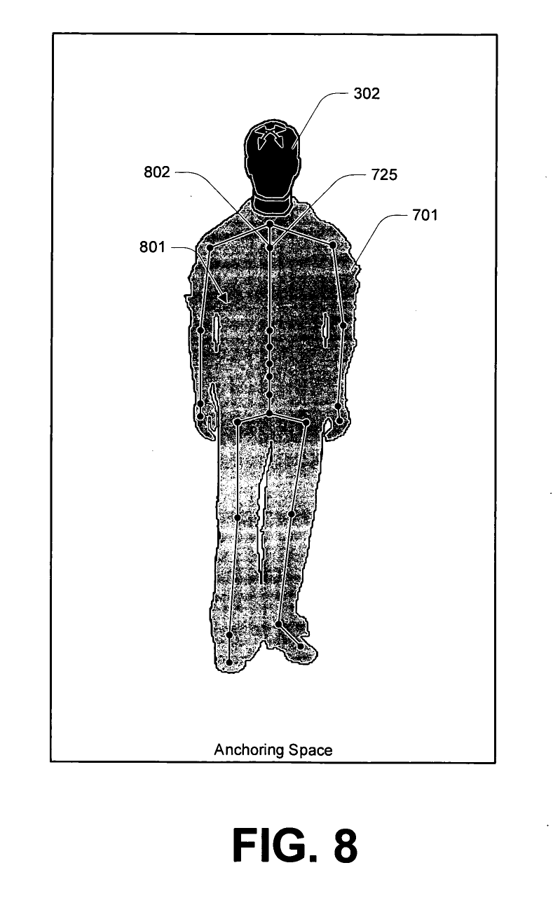

Following method 401, a method 601 is performed to allow the or each 3D scan to be anchored to a virtual body, in the form of a 3D modeled torso 701, in an anchoring space 702. This method is shown in FIG. 6, and described by reference to FIG. 7, FIG. 7A, FIG. 7B, and FIG. 8.

Virtual torso 701 is defined in the anchoring space, for example using conventional 3D animation techniques. This torso is shown in a neutral position, referred to as a “bind pose”. This bind pose conceptually equates to the normalized 3D scan configuration.

Step 602 includes importing the neutral 3D scan into the anchoring space 520, as shown in FIG. 7 and FIG. 7A. The anchoring space has a different predefined origin as compared to space 303, and as such the 3D scan appears in a different spatial location and configuration.

Step 603 includes allowing manipulation of the 3D scan in the anchoring space to “fit” torso 701, as shown in FIG. 7A and FIG. 7B. In the present embodiment this manipulation is carried out by a human animator by way of a graphical user interface (such as Maya) that provides functionality for displaying space 702 and allowing manipulation of scan 302 in space 702. This manipulation includes movement in three dimensions, rotation, and scaling. “Fit” is in some embodiments a relatively subjective notion—the animator should be satisfied that the virtual character defined is looking forward in a neutral manner that is appropriate for the neutral bind pose.

In other embodiments manipulation is in part or wholly automated. It will be appreciated from the teachings herein that this may be achieved by defining torso 701 and anchor point 216′ in a manner complementary to such automation.

Once the animator is satisfied with the position of the scan with respect to the torso a signal is received at 604 to indicate that the 3D scan is ready for anchoring. Step 107 is then performed so as to determine a transformation for applying the 3D head scan to a virtual modeled torso such that the scan anchor location is fixed with respect to the corresponding object anchor location on the virtual object. The scan anchor location and object anchor location each suggest a location, and an orientation in three dimensions-such as at least three non-identical unit vectors to define front, left side and upward directions.

In the present example, the anchoring transformation performed at step 107 includes a transformation to match the normalized scanned pose for each frame (based on frame-specific neutral pose transformations) with the modeled torso bind pose. In some cases, a game space transformation is also applied to apply in-game movements of the object anchor location to the scan anchor location such that the scanned head moves with the modeled torso over the course of in-game animations.

Manipulation of the 3D scan in the anchoring space defines a relationship between 3D scan and the virtual object, and more particularly a relationship between the scan anchor location 216′ and an object anchor location on torso 701. Referring to FIG. 8, torso 701 presently includes a virtual skeleton 801 having a plurality of joints that define the range of movement of the torso in a virtual environment, and object anchor location 725 is defined at the chest joint 802. In other embodiments alternate object anchor locations are defined. Furthermore, in some embodiments an object anchor location is defined at the selection of the animator, whilst in some embodiments the object anchor location is predefined.

On the basis of the reference data associated with scan 302 and corresponding positional and scale data associated with scan 203 in space 702 following manipulation, data is derived indicative of the 3D offset, rotation and scale that has been applied to the 3D scan over the course of the manipulation. Furthermore, data is available regarding the relative spatial position and orientation of the scan anchor location with respect to the object anchor location. From this, the anchoring transformation is defined such that the scan is appropriately transformed in terms of 3D offset, rotation and scale and such that the scan anchor location is correctly positioned with respect to the object anchor location.

Once the anchoring transformation is defined, the anchoring is applied in-game at 606 by defining appropriate game-space transformations. These transformations, in some embodiments, provide a framework for transforming the 3D scan head so as to follow the modeled torso over the course of in-game animations. More specifically, the scan anchor location maintains a constant relationship with the object anchor location in terms of 3D offset, rotation and scale and such that the scan anchor location is correctly positioned with respect to the object anchor location as the object anchor location moves with the modeled torso.

In some embodiments the object anchor location move in-game relative to the virtual object. By way of example, the object anchor location may rotate, although the object remains still. In such a case, the game space transformations correspondingly rotate the 3D scan. It will be appreciated that, where the 3D scan is a head and the object a body, such an approach allows the animation of a turning head. In another example, the object anchor location may move relative to the object. For example, this would allow for a head to be removed from its body, should the need arise.

The overall anchoring process applies the anchoring transformation across the plurality of 3D scans such that the scan anchor location remains fixed with respect to the object anchor location. This means that:
The torso is able to move freely in accordance with its range of movement provided by the virtual skeleton. For example, in the context of an in-game environment, the torso performs various predefined movements. Throughout such movements, the scan anchor location maintains its relationship with respect to the object anchor location at chest joint 802.
The head is able to move over the course of a 3D scan animation. Once again, throughout this movement, the scan anchor location maintains its relationship with respect to the object anchor location at chest joint 802.

It follows that movements of the virtual character's head—such a facial expressions, mouth movements, turning at the neck, and so on—are performed on the basis of 3D scan animations. On the other hand, movements of the character's torso—such as arm waving, walking and, so on—are performed on the basis of traditional 3D animations using skeleton 801.

In the examples considered above, it is assumed that the anchoring allows a 3D scan to follow a virtual object. That is, a transformation is applied so that the scan anchor location remains fixed with respect to a moving object anchor location. However, in other examples, the anchoring allows a virtual object to follow a 3D scan. That is, a transformation is applied so that the object anchor location remains fixed with respect to a moving scan anchor location.

In further embodiments, the virtual object is also a 3D scan. That is, one might consider the 3D scan as a “primary 3D scan” having a “primary scan anchor location” and the virtual object as a “secondary 3D scan” having a “secondary scan anchor location”. The anchoring applies the primary scan anchor location to the secondary scan anchor location.

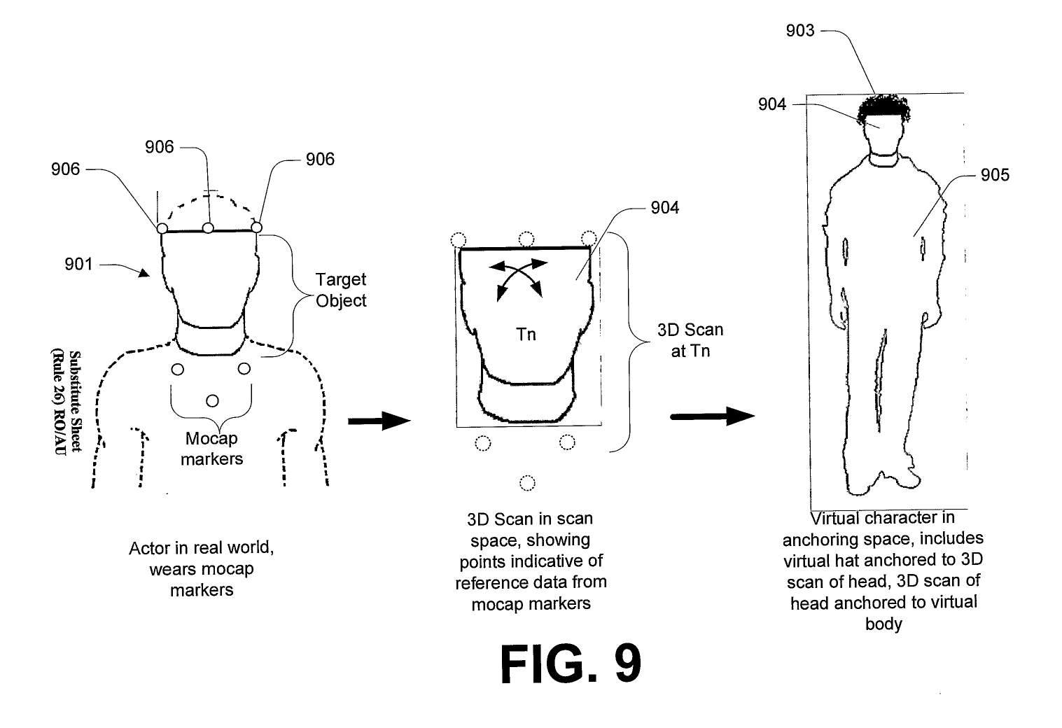

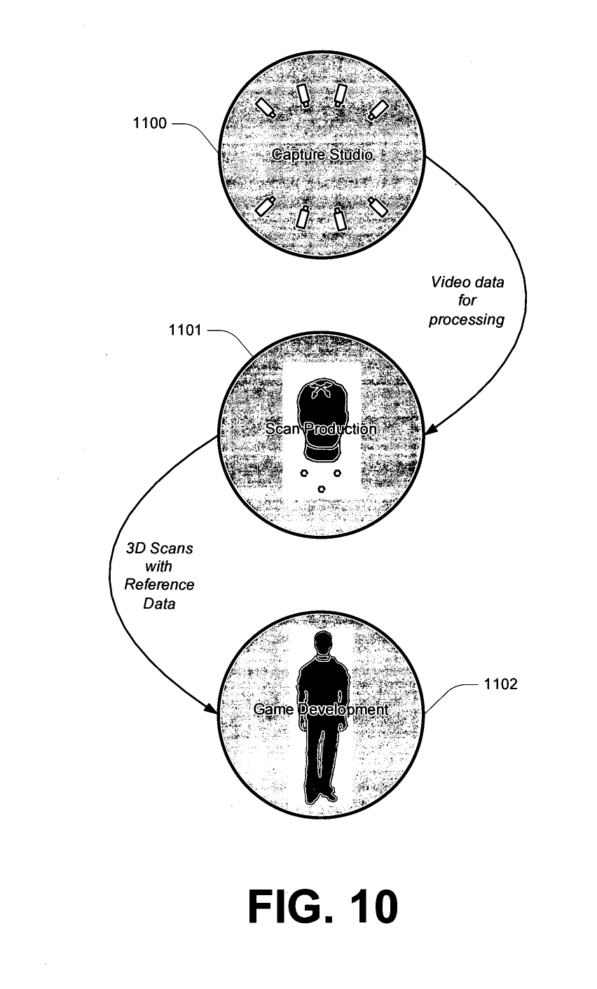

In the embodiment of FIG. 9, the target object 901 does not include the top of the actor's head 902. It will be appreciated that, in the contact of generating a 3D scan, hair presents practical and technical difficulties. In overview, the approach adopted in the embodiment of FIG. 9 includes anchoring a virtual headpiece 903 to a 3D scan 904 of the target object 901. 3D scan 904 is anchored to a virtual torso 905 in a similar fashion to embodiments previously discussed.

Headpiece 903 is, in some embodiments, a static headpiece such as a simple hat or helmet. However, in other embodiments it is an active headpiece, such as a wig defined by virtual hair that behaves in a manner determined by movement and environmental constraints.

In the present embodiment, two scan anchor locations are defined. The first of these is used to anchor the 3D scan to the torso, as in examples above. The second is used to anchor the virtual headpiece to the 3D scan. For this second scan anchor location, reference points are defined by three mocap markers 906 positioned about the actor's forehead. These mocap markers allow second reference data to be defined and associated with the 3D scan, and in the present embodiment assist in clipping the upper portion of the actor's head so that it is excluded from the 3D scan.

In an alternate embodiment, rather than positioning mocap markers about the actor's forehead, a patterned hat or the like is used. In some embodiments the second scan anchor location is defined without the need for mocap markers, for example on the basis of an assumption that the top of the head is rigid, allowing for alignment algorithms.

The fitting of the 3D scan with respect to the torso, and the virtual headpiece with respect to the 3D scan is carried out substantially in the manner described in previous examples. An anchoring transformation is defined for anchoring the 3D scan to the torso, as described above, and a further anchoring transformation defined for anchoring the virtual headpiece to the 3D scan in a similar manner. It will be appreciated that if the 3D scan, over the course of a 3D scan animation, behaves such that the head turns, the headpiece turns in unison with the head.

As discussed above, anchoring transformations may be applied to either a 3D scan or a virtual object. By way of example, where a 3D scan is interposed between a virtual body and a virtual headpiece, one approach is to:
Apply an anchoring transformation to the 3D scan for the purpose of anchoring to the virtual body.
Apply an anchoring transformation to the virtual headpiece for the purpose of anchoring to 3D scan.

In the case of the latter, one embodiment makes use of an approach whereby the headpiece is initially normalized by reference to the second scan anchor location (i.e. the top of the head). This includes determining a normalizing transformation for normalizing the 3D scan by reference to a neutral configuration for the second scan anchor location at T₀. The general approach is similar to that described by reference to FIG. 5, however, the second scan anchor location (top of the head) remains still over the course of the plurality of frames An inverse of this normalizing transformation is then defined, and applied to the virtual headpiece such that it follows the 3D scan during animation. An anchoring transformation then anchors the object anchor location of the headpiece to the second scan anchor location (top of head), thereby to achieve appropriate relative positioning in terms of location and orientation. That is, the headpiece is appropriately anchored to the head, and follows both the overall movement of the head (as effected by movement of the virtual body) and subtle movements of the upper head (as effected by the 3D scan).

Although the above examples consider a virtual headpiece that is attached to the top of the 3D scan (such as a hat or wig), other virtual objects may also be used in addition or as alternatives. Examples include the likes of glasses, body piercings, earrings, facial hair, and so on.

To provide a general overview of transformations considered herein, the general approach in some embodiments is to:
Firstly, apply a normalizing transformation transformation such that, for each 3D scan, the scan anchor location is normalized to a neutral pose.
Secondly, apply an anchoring transformation such that, for any or all of the 3D scans, the scan anchor location is located in a selected position relative to an object anchor location on a virtual object.
Finally, apply game space transformations such that, as the object anchor location moves in the context of a modeled animation, the scan anchor location moves correspondingly to maintain the relative positioning defined by the anchoring transformation.

For some embodiments, in the context of applying a 3D scan of a head and neck to a modeled torso, the following exemplary procedure is carried out:
Video footage of an actor is captured at a plurality of cameras.
The video footage is used to generate a 3D scan of the actor's head and neck.
A reference array (such as one or more mocap markers) is used to associate reference data with the 3D scan. This reference array identifies a predefined location defined with respect to the target object, such as a point at the base of the neck. These allow for the determination of reference data for the 3D scan, the reference data being indicative of a scan anchor location corresponding to the predefined location.
A normalizing transformation is applied across the 3D scans such that the scan anchor location is similarly located and oriented with respect to a common origin across the 3D scans. As such, the scan anchor location adopts a common neutral configuration across the scans.
The 3D scan is manipulated using a tool such as Maya so that is fits the modeled torso. This defines a spatial relationship (position and orientation) between the scan anchor location and an object anchor location on the torso, such as a chest joint. That is, a relationship is defined between the base of the neck and the chest joint.
An anchoring transformation is determined for transforming any of the 3D scans (with scan anchor location in neutral configuration following the frame specific transformations) in accordance with the manipulation. This transformation, once applied to any one of the 3D head/neck scans, essentially transforms that 3D scan to fit the torso.
A game space transformation is determined. This transformation anchors the base of the neck to the chest joint so that these locations maintain a constant spatial relationship (position and orientation) over the course of movement of the torso. As such, as the torso moves—for example in the context of video game animations—the scanned head follows the torso.

It will be appreciated that the above disclosure provides various useful systems and methods for applying a 3D scan of a physical target object to a virtual environment.

FIG. 10 illustrates one commercial implementation of the present technology. Although, in some cases, the entire procedure of capturing to anchoring is performed by a single party, in other cases the overall procedure is performed by a plurality of discrete parties.

In the context of FIG. 10, three parties are illustrated. These are:
A capture studio party 1100.
A scan production party 1101.
A game development party 1102.

In overview, party 1100 is responsible for capturing video data of the target object and reference array (assuming a visual mocap technique is applied). This video data is then exported to party 1101. For example, the data may be communicated electronically, or stored on carrier media such as one or more DVDs or the like. Party 101 processes the video data thereby to generate a 3D scan animation of the target object, and associate with that scan reference data indicative of a scan anchor location, based on methods outlined further above. For example, the 3D scan animation is generated based on perceived surface characteristics of the target object, and the reference data is defined on the basis of the location of the reference array.

Party 1101 exports a data file to party 1102, the data file including a 3D scan animation and corresponding reference data indicative of a scan anchor location. Party 1102 then performs anchoring of the 3D scan to a virtual object based on the reference data, thereby to apply the scan to a video game or the like. That being said, the present technology is by no means limited to video game applications, and finds further use in boarder fields of animation.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., an liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be includes in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while some diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that are for execution on one or more processors, e.g., one or more processors that are part of building management system. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media, a medium bearing a propagated signal detectable by at least one processor of one or more processors and representing a set of instructions that when executed implement a method, a carrier wave bearing a propagated signal detectable by at least one processor of the one or more processors and representing the set of instructions a propagated signal and representing the set of instructions, and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner. In particular, it will be appreciated that, as used herein, the descriptors “first” and “second”, as they apply to transformations, should not imply that an anchoring transformation is performed prior to a normalising transformation. Rather, the descriptors are used to differentiate between transformations, and in various embodiments discussed above a normalising transformation is applied prior to an anchoring transformation.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. (canceled)

2. A method for applying a 3D scan of a physical target object to a virtual environment, the method including the steps of:
(a) positioning the target object within a capture zone, the capture zone being defined in three dimensional space by the configuration of a set of capture devices;
(b) defining a reference array within the capture zone on or proximal the target object, the reference array being substantially fixed with respect to a predefined location defined with respect to the target object;
(c) capturing video at the capture devices;
(d) based on perceived surface characteristics of the target object, processing the captured video to generate a 3D scan of the target object;
(e) on the basis of the location of the reference array, processing the captured video to provide reference data for association with the 3D scan, the reference data being indicative of one or more characteristics of a scan anchor location for the 3D scan;
(f) on the basis of the reference data, determining an anchoring transformation for applying the 3D scan to a virtual object in the virtual environment such that the scan anchor location is fixed with respect to a corresponding object anchor location on the virtual object.

3. A method according to claim 2 wherein step (d) includes generating a plurality of 3D scans as sequential frames, and step (e) includes providing reference data for each one of these sequential frames.

4. A method according to claim 3 including the step of, on the basis of the reference data, defining a neutral configuration for the scan anchor location.

5. A method according to claim 4 wherein a normalising transformation is applied to the plurality of 3D scans such that the scan anchor location is provided in the neutral configuration across the plurality of 3D scans.

6. A method according to claim 5 wherein the anchoring transformation is applied subsequent to the normalising transformation thereby to anchor the plurality of 3D scans to the virtual object in the virtual environment across a corresponding plurality of frames such that the scan anchor location remains fixed with respect to the object anchor location.

7. A method according to claim 2 wherein the 3D scan is generated in a capture space, and step (f) includes applying the 3D scan to an anchoring space and manipulating the scan in the anchoring space to define a relationship between the 3D scan and the virtual object, and wherein the anchoring transformation is defined on the basis of the manipulation.

8. (canceled)

9. (canceled)

10. (canceled)

11. (canceled)

12. A method according to claim 7 wherein the 3D scan is applied to the anchoring space with the scan anchor location in a neutral configuration.

13. A method according to claim 12 wherein the virtual object adopts a predefined bind pose during the manipulation.

14. A method according to claim 13 wherein the anchoring transformation is indicative of the manipulation required in the anchoring space to position the scan anchor location in the neutral configuration to a selected location and orientation relative to the virtual object in the bind pose.

15. (canceled)

16. (canceled)

17. A method according to claim 2 wherein step (d) includes any one of the following:
application of controlled light patterns;
performing a visual hull technique;
performing a volume slicing technique;
stereo matching technique;
performing a volume estimation procedure.

18. A method according to claim 2 wherein the reference array includes one or more reference points.

19. (canceled)

20. (canceled)

21. (canceled)

22. A method according to claim 2 wherein the target object is part of a larger physical object, and the reference array is defined on or adjacent the larger physical object.

23. A method according to claim 22 wherein the reference array is defined on or adjacent the larger physical object at a location or locations apart from the target object.

24. A method according to claim 23 wherein the target object includes at least a portion of the head of an actor, and the reference array includes one or more reference points that are defined below the neck of the actor.

25. A method according to claim 24 wherein first and second reference points are defined substantially adjacent the actor's collarbone on the actor's front side.

26. (canceled)

27. (canceled)

28. (canceled)

29. (canceled)

30. (canceled)

31. A method according to claim 24 wherein the reference array is substantially fixed with respect to a preselected anatomic location on the actor's body.

32. (canceled)

33. (canceled)

34. A method according to claim 2 wherein step (d) includes, on the basis of the location of the reference array, defining an extremity for the 3D scan.

35. A method according to claim 2 wherein step (d) includes, on the basis of the location of the reference points, defining a clipping plane for the 3D scan.

36. (canceled)

37. (canceled)

38. (canceled)

39. (canceled)

40. A system for applying a 3D scan of a physical target object to a virtual environment, the system including:
an interface for receiving video data from a set of capture devices, the capture devices defining in three dimensional space a capture zone, the capture zone for containing the target object and a reference array defined on or proximal the target object, the reference array being substantially fixed with respect to a predefined location defined with respect to the target object;
a first processor for, based on perceived surface characteristics of the target object, processing the captured video to generate a 3D scan of the target object;
a second processor for, on the basis of the location of the reference array, processing the captured video to provide reference data for association with the 3D scan, the reference data being indicative of one or more characteristics of a scan anchor location for the 3D scan;
a third processor for, on the basis of the reference data, determining an anchoring transformation for applying the 3D scan to a virtual object in the virtual environment such that the scan anchor location is fixed with respect to a corresponding object anchor location on the virtual object.

41. (canceled)

42. (canceled)

43. (canceled)

44. (canceled)

45. (canceled)

46. (canceled)

47. (canceled)

48. A method for providing a 3D scan, the method including the steps of:
receiving video data indicative of video captured at within a capture zone, the capture zone being defined in three dimensional space by the configuration of a set of capture devices;
processing the video data based on perceived surface characteristics of the target object, thereby to generate a 3D scan of the target object;
processing the video data to identify a reference array, and on the basis of the location of the reference array, processing the captured video to define reference data for association with the 3D scan, the reference data being indicative of one or more characteristics of a scan anchor location for the 3D scan.
